(19) United States
(12) Patent Application Publication
(10) Pub. No.: US 2014/0127125 A1
(43) Pub. Date: May 8, 2014

(54) Method for Preparing Lithium Manganese Oxide by Solid-Phase Reaction

(71) Applicants: Kang-Sup Chung, Yuseong-gu Daejeon (KR); Tae Gong Ryu, Yuseong-gu Daejeon (KR); Byoung Gyu Kim, Yuseong-gu (KR); Jung Ho Ryu, Yuseong-gu Daejeon (KR)

(72) Inventors: Kang-Sup Chung, Yuseong-gu Daejeon (KR); Tae Gong Ryu, Yuseong-gu Daejeon (KR); Byoung Gyu Kim, Yuseong-gu (KR); Jung Ho Ryu, Yuseong-gu Daejeon (KR)

(73) Assignee: KOREA INSTITUTE OF GEOSCIENCE AND MINERAL RESOURCES (KIGAM), Daejeon (KR)

(21) Appl. No.: 13/640,087

(22) PCT Filed: May 4, 2012
(86) PCT No.: PCT/KR2012/003520

§ 371 Date: Mar. 15, 2013

(30) Foreign Application Priority Data
Jun. 30, 2011 (KR) 10-2011-0065161

(51) Int. Cl. C01D 15/02

(52) U.S. Cl. CPC C01D 15/02
USPC 423/599

(57) ABSTRACT

The present invention relates to a method for preparing lithium manganese oxide used as a lithium adsorbent and, more particularly, to a method for preparing lithium manganese oxide by a solid-phase reaction. According to the preparation method of the present invention, since the entire reaction is carried out only by the solid-phase reaction, it is possible to solve the problem of waste fluids produced during a conventional liquid-phase reaction, and the preparation method of the present invention is a single process, which is suitable for mass production.

### TECHNICAL FIELD

The present invention relates to a method for preparing lithium manganese oxide used as a lithium adsorbent and, more particularly, to a method for preparing lithium manganese oxide by a solid-phase reaction.

### BACKGROUND ART

At present, lithium and lithium compounds are used in a wide range of fields such as secondary battery materials, refrigerant adsorbents, catalysts, medicines, etc. and are one of the important resources that have attracted attention as nuclear fusion energy resources. Moreover, it is expected that the demand for the lithium and lithium compounds will also increase in the technical fields of high-capacity batteries, electric vehicles, etc.

As such, lithium is an important resource that can be used in various fields and its importance increases, but the world's lithium reserves are only about 2 to 9 million tons. In order to cope with the limited reserves, extensive research aimed at developing technologies for ensuring lithium resources via various routes has continued to progress, and as part of the research, extensive research aimed at efficiently recovering lithium dissolved in a small amount in aqueous solutions such as seawater, bittern, waste fluids of lithium batteries, etc. has continued to progress.

As conventional methods for recovering lithium, a method for reducing lithium ions by an electrochemical method, a method for reducing lithium oxide with magnesium or aluminum metal, etc. have been known. Alternatively, a method for recovering lithium using an adsorbent that selectively adsorbs lithium ions has been studied. The main concern of these studies using lithium adsorbents is to develop a high-performance adsorbent having high selectivity to lithium ions and excellent adsorption and desorption performance.

As a result of these studies, there is a known method for preparing a powder that facilitates adsorption and desorption of lithium by a solid-phase reaction using manganese oxide or gel process, and the powder prepared by such a method has been used as a material for a positive electrode for a lithium secondary battery, a material for a lithium adsorbent, etc.

In particular, an adsorbent based on lithium manganese oxide having a spinel structure has been widely used to selectively adsorb lithium ions from seawater and bittern.

Starting from the synthesis of LiMn₂O₄, adsorbents such as Li_{1.33}Mn_{1.67}O₄, Li_{1.6}Mn_{1.6}O₄, etc. have been developed and, among them, Li_{1.6}Mn_{1.6}O₄ has been considered as the best lithium adsorbent. The reason for this is that acid treatment using HCl is required to extract lithium ions from the adsorbent, and when the oxidation number of manganese in the lithium manganese oxide is 3, the manganese may be dissolved during the acid treatment, and thus an adsorbent comprising only Mn⁺⁴ resistant to acid is required, and the content of Li contained in the adsorbent also affects the performance of the lithium adsorbent.

The synthesis of lithium adsorbents developed so far has been achieved by a liquid-phase reaction (hydrothermal reaction and sol-gel reaction) and solid-phase reaction. However, the synthesis of Li_{1.6}Mn_{1.6}O₄ has been achieved by the liquid-phase reaction, but the synthesis route via the solid-phase reaction has not been known.

According to currently known methods for synthesizing Li_{1.6}Mn_{1.6}O₄, it has been known that an intermediate product, LiMnO₂, is synthesized by a hydrothermal reaction using γ-MnOOH and LiOH as reactants and then a final product, Li_{1.6}Mn_{1.6}O₄, is synthesized by thermal treatment under an air atmosphere. However, it is considered that these methods are not suitable for mass production due to waste fluids produced during the hydrothermal reaction and in terms of reaction scale, and thus there is a need to develop an alternative method.

### DISCLOSURE

### [Technical Problem]

Accordingly, the present invention has been made to solve the above-described problems, and an object of the present invention is to provide a method for preparing lithium manganese oxide used as a lithium adsorbent, in which an intermediate product, LiMNO₂, and a final product, Li_{1.6}Mn_{1.6}O₄ are prepared only by a solid-phase reaction instead of a conventional hydrothermal reaction.

### [Technical Solution]

To accomplish the above objects of the present invention, the present invention provides a method for preparing LiMnO₂, the method comprising the step of preparing LiMnO₂ by mixing and thermally treating reactants including at least one lithium compound selected from the group consisting of lithium carbonate, lithium hydroxide, lithium nitrate, and lithium acetate and at least one manganese or manganese compound selected from the group consisting of manganese, manganese oxide, and manganese hydroxide.

The mixing molar ratio of the reactants is preferably 0.9≦Li/Mn≦1.1.

The thermal treatment is preferably carried out at 400 to 800° C. for 2 to 24 hours.

The thermal treatment is preferably carried out under an inert gas atmosphere.

Moreover, the present invention provides a method for preparing Li_{1.6}Mn_{1.6}O₄, the method comprising the steps of: (1) preparing LiMnO₂ by mixing and thermally treating reactants including at least one lithium compound selected from the group consisting of lithium carbonate, lithium hydroxide, lithium nitrate, and lithium acetate and at least one manganese or manganese compound selected from the group consisting of manganese, manganese oxide, and manganese hydroxide; and (2) preparing Li_{1.6}Mn_{1.6}O₄ by thermally treating the prepared LiMnO₂.

The mixing molar ratio of the reactants in step (1) is preferably 0.91≦Li/Mn≦1.1.

The thermal treatment in step (1) is preferably carried out under an inert gas atmosphere. The thermal treatment in step (1) is preferably carried out at 400 to 800° C. for 2 to 24 hours.

The thermal treatment in step (2) is preferably carried out under an air atmosphere.

The thermal treatment in step (2) is preferably carried out at 400 to 700° C. for 2 to 24 hours.

Furthermore, the present invention provides a method for preparing Li_{1.6}Mn_{1.6}O₄, the method comprising the step of: mixing and thermally treating reactants including at least one lithium compound selected from the group consisting of lithium carbonate, lithium hydroxide, lithium nitrate, and lithium acetate and at least one manganese or manganese compound selected from the group consisting of manganese, manganese oxide, and manganese hydroxide.

The mixing molar ratio of the reactants is preferably 0.91≦Li/Mn≦1.1.

An intermediate product is preferably LiMnO₂. The thermal treatment is preferably carried out at 400 to 800° C. for 4 to 48 hours.

The thermal treatment is preferably carried out under an inert gas atmosphere at the beginning of the reaction and, after the production of the intermediate product, carried out in an air atmosphere.

[Advantageous Effects]

According to the preparation method of the present invention, since the entire reaction is carried out only by the solid-phase reaction, it is possible to solve the problem of waste fluids produced during the conventional liquid-phase reaction, and the preparation method of the present invention is a single process, which is suitable for mass production.

### DESCRIPTION OF DRAWINGS

FIG. 1 shows XRD patterns of lithium manganese oxides prepared by a solid-phase reaction of the present invention, in which (a) shows the result of the reaction at 700° C. under a nitrogen atmosphere for 6 hours, and (b) shows the result of the following reaction at 500° C. under an air atmosphere for 8 hours.

### BEST MODE FOR CARRYING OUT THE INVENTION

Hereinafter, the present invention will be described in detail.

The present invention relates to a method for preparing Li_{1.6}Mn_{1.6}O₄ which is known as having excellent adsorption capacity among lithium manganese oxides used as lithium adsorbents, in which the entire reaction is carried out only by a solid-phase reaction to fundamentally solve the problem of waste fluids produced during a conventional hydrothermal reaction and to realize mass production of Li_{1.6}Mn_{1.6}O₄.

Accordingly, the present invention provides a method for preparing LiMnO₂, the method comprising the step of mixing and thermally treating reactants including at least one lithium compound selected from the group consisting of lithium carbonate, lithium hydroxide, lithium nitrate, and lithium acetate and at least one manganese or manganese compound selected from the group consisting of manganese, manganese oxide, and manganese hydroxide.

The reactants are preferably Li₂CO₃ and Mn₂O₃. The mixing molar ratio of the reactants is preferably 0.9≦Li/Mn≦1.1. If the mixing ratio of the reactants exceeds the above range, the amount of impurities produced increases, which is problematic.

The thermal treatment is preferably carried out at 400 to 800° C. for 2 to 24 hours in an inert gas atmosphere, preferably in an argon or nitrogen atmosphere. When the temperature and time of the thermal treatment are within the above range, it is possible to obtain a desired product containing substantially no impurities.

LiMnO₂, an intermediate product produced by the above method, may be prepared by a known method, for example, by a method of Ramesh Chitrakar et al., “Recovery of lithium from seawater using manganese oxide adsorbent (Li_{1.6}Mn_{1.6}O₄) derived from Li_{1.6}Mn_{1.6}O₄”, Ind. Eng. Chem. Res. 2001, 40, 2054-2058; Ramesh Chitrakar et al., “A new type of manganese oxide (MnO₂·0.5H₂O) derived from Li_{1.6}Mn_{1.6}O₄ and its lithium ion-sieve properties”, Chem. Matter. 2000, 12, 3151-3157, or by a method for preparing Li_{1.6}Mn_{1.6}O₄ of the present invention.

Moreover, the present invention provides a method for preparing Li_{1.6}Mn_{1.6}O₄, the method comprising the steps of: (1) preparing LiMnO₂ by mixing and thermally treating reactants including at least one lithium compound selected from the group consisting of lithium carbonate, lithium hydroxide, lithium nitrate, and lithium acetate and at least one manganese or manganese compound selected from the group consisting of manganese, manganese oxide, and manganese hydroxide; and (2) preparing Li_{1.6}Mn_{1.6}O₄ by thermally treating the produced LiMnO₂.

The reactants in step (1) are preferably Li₂CO₃ and Mn₂O₃. The mixing molar ratio of the reactants in step (1) is preferably 0.9≦Li/Mn≦1.1. If the mixing ratio of the reactants exceeds the above range, the amount of impurities produced increases, which is problematic. The thermal treatment is preferably carried out at 400 to 800° C. for 2 to 24 hours in an inert gas atmosphere, preferably in an argon or nitrogen atmosphere. When the temperature and time of the thermal treatment are within the above range, it is possible to obtain a desired product containing substantially no impurities.

The thermal treatment in step (2) is preferably carried out at 400 to 700° C. for 2 to 24 hours in an air atmosphere. When the temperature and time of the thermal treatment are within the above range, it is possible to obtain a desired product containing substantially no impurities.

Furthermore, the present invention provides a method for preparing Li_{1.6}Mn_{1.6}O₄, the method comprising the step of mixing and thermally treating reactants including at least one lithium compound selected from the group consisting of lithium carbonate, lithium hydroxide, lithium nitrate, and lithium acetate and at least one manganese or manganese compound selected from the group consisting of manganese, manganese oxide, and manganese hydroxide.

The reactants are preferably Li₂CO₃ and Mn₂O₃. The mixing molar ratio of the reactants is preferably 0.9≦Li/Mn≦1.1. If the mixing ratio of the reactants exceeds the above range, the amount of impurities produced increases, which is problematic. LiMnO₂ is produced as an intermediate product.

The thermal treatment is preferably carried out at 400 to 800° C. for 4 to 48 hours in an inert gas atmosphere, preferably in an argon or nitrogen atmosphere at the beginning of the reaction, and after the production of the intermediate product, the thermal treatment is preferably carried out in an air atmosphere. When the temperature and time of the thermal treatment are within the above range, it is possible to obtain a desired product containing substantially no impurities. A single-step reaction is possible by the above method and, when two-step reaction conditions are simplified to one-step reaction conditions, it is possible to prepare LiMnO_{2.5}(Li_{1.6}Mn_{1.6}O₄) by controlling the temperature and atmosphere.

[Mode for Invention]

Hereinafter, the present invention will be described in more detail with reference to the Examples.

### EXAMPLES

### Example 1: 2—Step Reaction

1. First Solid-Phase Reaction

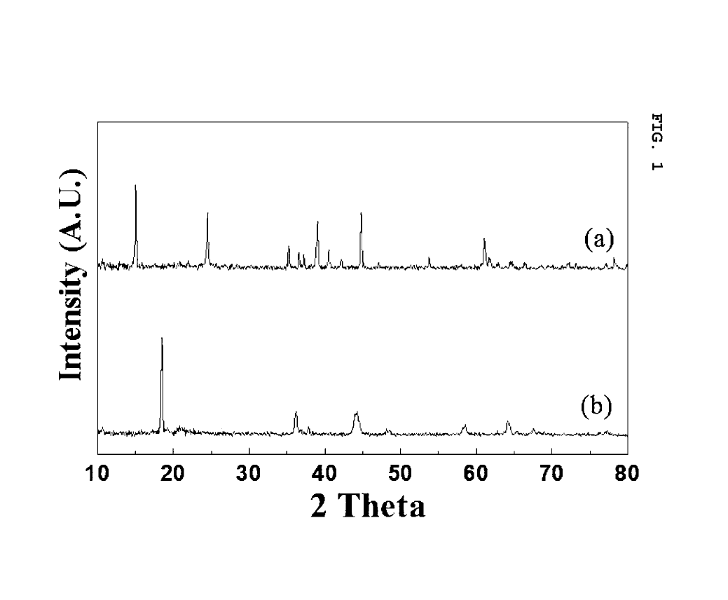

Li₂CO₃ and Mn₂O₃ were used as reactants. The molar ratio of Li/Mn was 1, and a ball mill was used to uniformly mix the reactants. Thermal treatment was carried out under a nitrogen atmosphere at 700° C. for 6 hours. The intermediate product obtained by the first solid-phase reaction was LiMnO₂ as shown in (a) of FIG. 1. The reaction mechanism can be represented by the following reaction scheme 1.

Li₂CO₃+Mn₂O₃→2LiMnO₂+CO₂(g) [Reaction Scheme 1]

2. Second Solid-Phase Reaction

The second solid-phase reaction was carried out under an air atmosphere at 500° C. for 8 hours using LiMnO₂ as the reactant. The final product obtained was Li_{1.6}Mn_{1.6}O₄ as shown in (b) of FIG. 2. The reaction mechanism can be represented by the following reaction scheme 2.

LiMnO₂+0.25O₂(g)→LiMnO_{2.5}(Li_{1.6}Mn_{1.6}O₄) [Reaction Scheme 2]

### Example 2: 1—Step Reaction

Li₂CO₃ and Mn₂O₃ were used as reactants. The molar ratio of Li/Mn was 1, and a ball mill was used to uniformly mix the reactants. Thermal treatment was carried out at 700° C. for 6 hours and then 500° C. at for 8 hours. The reaction was carried out in a nitrogen atmosphere at the beginning of the reaction and, after the production of the intermediate product, carried out in an air atmosphere, thus obtaining Li_{1.6}Mn_{1.6}O₄ as the final product.

1 A method for preparing Li_{1.6}Mn_{1.6}O₄, the method comprising the steps of:
(1) preparing LiMnO₂ by mixing and thermally treating reactants including at least one lithium compound selected from the group consisting of lithium carbonate, lithium hydroxide, lithium nitrate, and lithium acetate and at least one manganese or manganese compound selected from the group consisting of manganese, manganese oxide, and manganese hydroxide; and
(2) preparing Li_{1.6}Mn_{1.6}O₄ by thermally treating the prepared LiMnO₂.

2 The method of claim 1, wherein the mixing molar ratio of the reactants in step (1) is 0.9≦Li/Mn≦1.1.

3 The method of claim 1, wherein the thermal treatment in step (1) is carried out under an inert gas atmosphere.

4 The method of claim 1, wherein the thermal treatment in step (1) is carried out at 400 to 800° C. for 2 to 24 hours.

5 The method of claim 1, wherein the thermal treatment in step (2) is carried out under an air atmosphere.

6 The method of claim 1, wherein the thermal treatment in step (2) is carried out at 400 to 700° C. for 2 to 24 hours.

7 A method for preparing Li_{1.6}Mn_{1.6}O₄, the method comprising the step of: mixing and thermally treating reactants including at least one lithium compound selected from the group consisting of lithium carbonate, lithium hydroxide, lithium nitrate, and lithium acetate and at least one manganese or manganese compound selected from the group consisting of manganese, manganese oxide, and manganese hydroxide.

8 The method of claim 7, wherein the mixing molar ratio of the reactants is 0.91≦Li/Mn≦1.1.

9 The method of claim 7, wherein an intermediate product is LiMnO₂.

10 The method of claim 7, wherein the thermal treatment is carried out at 400 to 800° C. for 4 to 48 hours.

11 The method of claim 7, wherein the thermal treatment is carried out under an inert gas atmosphere at the beginning of the reaction and, after the production of the intermediate product, carried out in an air atmosphere.
